(19) United States
(12) Patent Application Publication
(10) Pub. No.: US 2025/0365218 A1
(43) Pub. Date: Nov. 27, 2025

(54) INTERACTIVE RADIO ACCESS NETWORK DEVELOPMENT

(71) Applicant: Cirrus360 LLC, Richardson, TX (US)

(72) Inventors: Alan Gatherer, Dallas, TX (US); Chaitali Sengupta, Richardson, TX (US); Sudipta Sen, Richardson, TX (US)

(21) Appl. No.: 18/670,971

(22) Filed: May 22, 2024

(51) Int. Cl. H04L 41/00; G06F 3/0484; G06F 8/34; G06F 40/20; H04L 51/02

(52) U.S. Cl. CPC H04L 41/20; G06F 3/0484; G06F 8/34; G06F 40/20; H04L 51/02

(57) ABSTRACT

Various aspects of the subject technology relate to systems, methods, and machine-readable media for cross-platform programmable network communication. The method includes receiving, via a conversational user interface (UI), a request from a user for a radio access network (RAN), the request including a description of a set of requirements for the RAN made in a conversation format. The method also includes generating a set of constraints for network hardware of the RAN based on the request. The method also includes providing, via the conversational UI, a description of the set of constraints to the user. The method also includes generating, based on an approval of the set of constraints from the user, a solution to a deployment for the network hardware of the RAN according to the set of constraints. The method also includes outputting a description of the solution including attributes of the solution.

### TECHNICAL FIELD

The present disclosure generally relates to radio access networks (RANs), and more particularly to implementing artificial intelligence/machine learning (AI/ML) to enhance RAN software development and operations in the RAN domain.

### BACKGROUND

Infrastructure costs for the telecommunications industry have been exploding as the industry moves to 5G wireless technology, and beyond. Of these costs, radio access network (RAN) costs are the highest. The RAN also consumes the most power of all the other telecommunications infrastructure elements. The cost drivers are not only the bill of materials for the infrastructure, but also the direct and indirect costs of development, maintenance, time-to-market, and upgrade flexibility of telecommunications products. The telecommunications industry has attempted to address this issue with a massive move to adopt innovate software solutions, dis-aggregated architectures, and off-the-shelf hardware. However, there are several technical challenges that must be addressed to make such concepts successful. Therefore, there is a need for a solution that addresses these problems in the context of an evolving and complex 5G standard.

### BRIEF SUMMARY

The subject disclosure provides for systems, methods, and machine-readable media for an interactive approach to assist customers with identifying and discovering constraints, parameter files, expected results, potential areas for optimization, or the like, in a desired RAN (e.g., open RAN RU (Radio Unit), DU (Distributed Unit), and CU (Centralized Unit)). The disclosed solutions enrich the telecommunications ecosystem that is available to customers (hereafter referred to as “users”) developing and deploying 5G networks.

According to one embodiment of the present disclosure, a computer-implemented method for programmable network development is provided. The method includes receiving, via a conversational user interface (UI), a request from a user for a radio access network (RAN), the request including a description of a set of requirements for the RAN. The method includes generating a set of constraints for network hardware of the RAN based on the request. The method includes providing, via the conversational UI, a second description of the set of constraints to the user. The method includes generating, based on an approval of the set of constraints from the user, a solution to a deployment for the network hardware of the RAN according to the set of constraints. The method includes outputting a third description of the solution including attributes of the solution.

According to one embodiment of the present disclosure, a system is provided including a processor and a memory comprising instructions stored thereon, which when executed by the processor, causes the processor to perform a method for programmable network development. The method includes receiving, via a conversational user interface (UI), a request from a user for a radio access network (RAN), the request including a description of a set of requirements for the RAN. The method includes generating a set of constraints for network hardware of the RAN based on the request, the set of constraints satisfying the set of requirements. The method includes providing, via the conversational UI, a second description of the set of constraints to the user. The method includes generating, based on an approval of the set of constraints from the user, a solution to a deployment for the network hardware of the RAN according to the set of constraints. The method includes outputting a third description of the solution including attributes of the solution.

According to one embodiment of the present disclosure, a non-transitory computer-readable storage medium is provided including instructions (e.g., stored sequences of instructions) that, when executed by a processor, cause the processor to perform a method for cross-platform programmable network communication. The method includes receiving, via a conversational user interface (UI), a request from a user for a radio access network (RAN), the request including a description of a set of requirements for the RAN. The method includes generating a set of constraints for network hardware of the RAN based on the request, the set of constraints satisfying the set of requirements. The method includes providing, via the conversational UI, a second description of the set of constraints to the user. The method includes generating, based on an approval of the set of constraints from the user, a solution to a deployment for the network hardware of the RAN according to the set of constraints. The method includes outputting a third description of the solution including attributes of the solution.

According to one embodiment of the present disclosure, a system is provided that includes means for storing instructions, and means for executing the stored instructions that, when executed by the means, cause the means to perform a method for cross-platform programmable network communication. The method includes receiving, via a conversational user interface (UI), a request from a user for a radio access network (RAN), the request including a description of a set of requirements for the RAN. The method includes generating a set of constraints for network hardware of the RAN based on the request, the set of constraints satisfying the set of requirements. The method includes providing, via the conversational UI, a second description of the set of constraints to the user. The method includes generating, based on an approval of the set of constraints from the user, a solution to a deployment for the network hardware of the RAN according to the set of constraints. The method includes outputting a third description of the solution including attributes of the solution.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary telecommunications infrastructure, according to certain aspects of the present disclosure.

FIG. 2 illustrates an exemplary deployment of a white box component in a telecommunications environment, according to certain aspects of the present disclosure.

FIG. 3 illustrates an exemplary LLM enabled RAN development and deployment system, according to certain aspects of the present disclosure.

FIG. 4 illustrates a RAN development loop, according to certain aspects of the present disclosure.

FIG. 5 illustrates a system configured for RAN development, in accordance with one or more implementations.

FIG. 6 illustrates an example flow diagram for RAN development, according to certain aspects of the present disclosure.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Infrastructure costs for the telecommunications industry have been exploding as the industry moves to 5G wireless technology, and beyond. Of these costs, radio access network (RAN) costs are the highest. The RAN also consumes the most power of all the other telecommunications infrastructure elements. The cost drivers are not only the bill of materials for the infrastructure, but also the direct and indirect costs of development, maintenance, time-to-market, and upgrade flexibility of telecommunications products.

At the developmental stage of RANs, constraints for variables used in RAN language descriptions must be defined. Constraints in RAN designs refer to the limitations or boundaries that must be considered (e.g., spectrum availability, interference, capacity, latency, and energy efficiency) for deployment. The constraints guide the RAN design, deployment, and operation to achieve desired performance and efficiency targets. Constraints may be expressed as mathematical expressions, functions, linear inequalities (e.g., maximum transmit power, minimum signal-to-noise ratio), equalities (e.g., resource allocation balance), or the like. RANs may also be constrained by hardware abstractions that define logical descriptions of how hardware components behave. The choice of constraints in RAN design and optimization depends on the specific requirements and objectives of the network (e.g., coverage, capacity, quality of service, and energy efficiency). Constraints must be carefully defined to ensure that outputs are feasible and practical, considering factors including, but not limited to, hardware limitations, regulatory requirements, and user demands.

Defining constraints in a 5G network introduces significant complexities. Constraints must be described as programable language in order to be implemented in a RAN, requiring a deep understanding of the surrounding telecommunications ecosystem and creating RAN programable language. If constraints are not properly defined, it can lead to increased costs during development and deployment of the RAN. Additionally, users may not always consider the full range of parameters that can impact the achievement of their desired outcomes when designing RAN programable language for a deployment.

Embodiments of the disclosure address the above-described problems by providing an analytics system that incorporates an interactive method utilizing a large language model (LLM) to assist users with identifying and discovering constraints, parameter files, expected results, potential areas for optimization, or the like. The analytics system is configured to generate precise machine-readable language descriptions. The interactive method may include an Artificial Intelligence (AI) model embedded in a user interface. The user interface is designed to utilize the LLM to interact with users, understand their deployment objectives, and generate a network programmable language accordingly, without any false or imagined information (i.e., hallucinations). This ensures a more precise and efficient system operation. In some implementations, the user interface may be provided as a service, accessible through cloud-based or on-premise platforms, and/or LLM interfaces.

In some implementations, the RAN programable language may be a RAN domain specific language (R-DSL). Processing the R-DSL may lead to configuration of the hardware resources (e.g., SoC, CPU, accelerators, etc.) to implement the desired constraints in the R-DSL. The R-DSL may be a declarative programming language that is hardware platform independent (e.g., hardware agnostic). The R-DSL may be cognizant of RAN specific requirements such as real-time constraints for each task. The R-DSL may include parameter files that manage and define constraints between parameters in streams, flows, modifiers, etc., across hardware and software applications and pipelines.

A user may input descriptions of a RAN (e.g., new RAN or modifications to an existing RAN) at the user interface using a conversational and informal format. The input descriptions may include various constraints and parameters. By non-limiting example, a user may request a 5G RAN solution with a modular, service-based architecture comprising fewer than 20 virtualized network function (VNF) cores capable of delivering a minimum throughput of 100 megabits per second (Mbps) to ensure a high-quality user experience, while also supporting adaptive throughput management to optimize overall network performance. The analytics system may be configured to generate RAN programable language defining constraints of the desired RAN based on the request. The RAN programable language may define a deployment as a specific hardware and software implementation of the 5G infrastructure that meets the user's needs. According to embodiments, the analytics system may be integrated (or communicatively coupled) with an automation platform configured to generate solutions that meet deployment goals of the RAN based on the RAN programable language. The automation platform may be configured to build, test, release, and deploy solutions to hardware components (e.g., a 5G modem) that allow a device, such as a smartphone or mobile hotspot, to connect to and communicate over 5G networks. The solutions may be determined based on the RAN programable language, an architectural model for the network hardware (e.g., including abstract hardware descriptions) and may include system constraints (e.g., in RAN programable language).

The solutions may be a specific implementation of a 5G infrastructure. The solution may include a specification of the deployment and analytics explaining the deployment and its metrics. A solution may include deployable system configurations based on the provided inputs. According to embodiments, the automation platform may further include an analytics database storing analytics reports, figures, graphics, feedback, suggestions, advice, or the like, output by the automation platform. The AI model may be configured to produce responses on the user interface drawing on the information from the analytics database. According to embodiments, the AI model can extend the conversation with the user by asking more questions via the user interface. The questions are designed to gather further information, suggestions, feedback, and so on. The conversation may continue until a specific parameter is fully understood (e.g., grounded) and a formula (i.e., constraint) can be created based on the description of the specific parameter, derived from the conversation. By non-limiting example, the AI model may inform the user that a desired parameter is not permissible based on an overview of the request. Based on the conversation between the user and the AI model, the analytics system may generate RAN programable language (i.e., code) for a deployment specific to the user's request, output reports, suggested improvements, details about system configurations in a provided solution, and/or an updated solution.

The disclosed subject matter simplifies and optimizes development of innovative RAN solution. Aspects of embodiments include enabling the user, through the user interface, to ask exploratory and information seeking questions regarding a solution (e.g., by referencing the analytics database). For example, the user may inquire about projected outcomes based on one or more changes, explanations for one or more aspects of the analytics database, reasonings behind various outputs, decisions, and/or defined constraints in a provided solution, potential restrictions of the provided solution, etc. In response to the user's inquiries, using the LLM, the specific parameter can provide human level responses and explanations via the user interface.

The disclosed system addresses a problem in traditional telecommunications systems tied to computer technology, namely, the technical problem of planning, coding, and building open, real-time, high reliability RAN deployments. The disclosed system solves this technical problem by providing a solution also rooted in computer technology, namely, by providing an AI-based conversational approach to gain a better understanding of the user's needs, ensure that proposed RAN solutions match the user's requirements, ensure properties the user has requested align with what is available in the RAN, and identify any misalignments, ultimately working towards a solution that better meets the user's requirements. This conversational approach enables users to engage in a more interactive way by prompting users with questions to help fill in areas where, for example, the user's knowledge is incomplete, determine alignment between system configurations and user requirements, inquire about any properties the user may have missed or not accounted for, or the like.

It is understood that the described systems and methods may be applied (beyond RANs) to any real-time system (RTS), including open RAN architecture components such as the Radio Unit (RU), Distributed Unit (DU), and Centralized Unit (CU).

Several implementations are discussed below in more detail in reference to the figures.

### Example Architecture

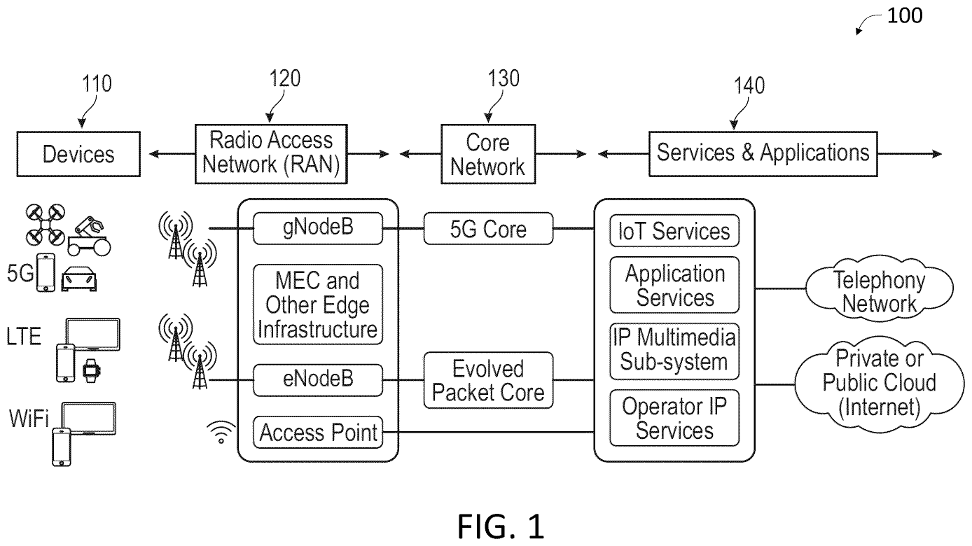

FIG. 1 illustrates an exemplary telecommunications infrastructure 100, according to certain aspects of the present disclosure. The telecommunications infrastructure 100 may include multiple devices 110 communicatively coupled to a radio access network (RAN) 120. For example, the devices 110 may include 5G/LTE/Wi-Fi enabled devices, such as, including, but not limited to, drones, smart cars, smart phones, smart televisions, smart watches, other smart devices, and the like. In an implementation, the RAN 120 may include gNodeB's, eNodeB's, Multi-Access Edge Computing (MEC) and other edge infrastructures, access points, and the like.

The RAN 120 may be communicatively coupled to a core network 130. For example, the core network 130 may include a 5G core network, an evolved packet core network, and the like. The core network 130 may be communicatively coupled to multiple services and applications 140. For example, the services and applications 140 may be housed on various internet servers for IoT services, applications, IP multimedia sub-systems, operator IP services, and the like. The servers may be coupled to a telephone network, private or public cloud, the Internet, etc.

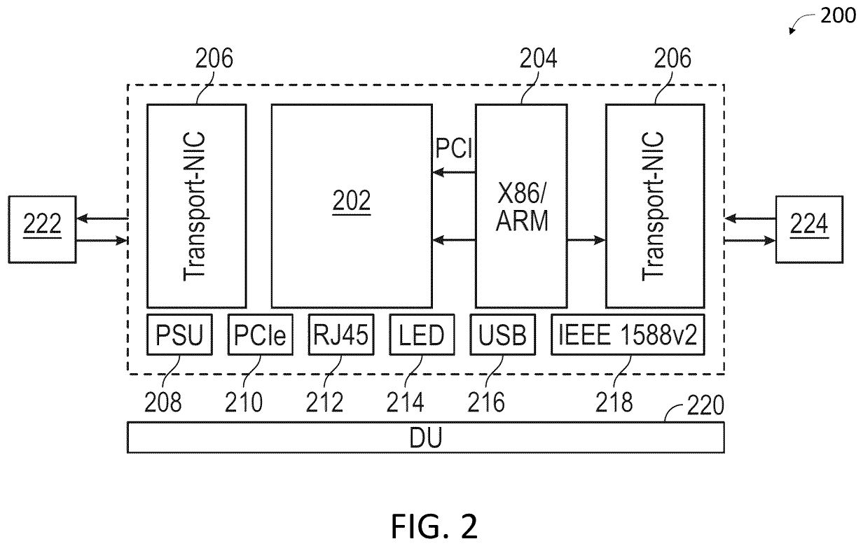

FIG. 2 illustrates an exemplary deployment 200 of a white box component 202 in a telecommunications environment, according to certain aspects of the present disclosure. For example, the white box component 202 may be implemented with the support of a network toolchain. According to aspects, the network toolchain may be included on a cloud server. The white box component 202 may be communicatively coupled to a processor 204 via a peripheral component interconnect express (PCIe) interface 210, or the like. For example, the processor 204 may include an x86/ARM processor, or the like. The processor 204 may be communicatively coupled to a transport network interface controller (NIC) 206, or the like.

According to aspects, the deployment 200 may further include a power supply unit (PSU) 208, the PCIe 210, a network connector (e.g., RJ45 or the like) 212, LED 214, USB 216, and a protocol 218 (e.g., IEEE 1588v2 or other Precision Time Protocol (PTP), or the like). The deployment 200 may be coupled to a low layer split interface 222 and/or an F1 interface 224 via the NIC 206. In an implementation, the deployment 200 may sit on top of a DU 220. Embodiments are not limited to a DU 220 and may include some other open RAN (O-RAN) architecture component (e.g., a CU or RU).

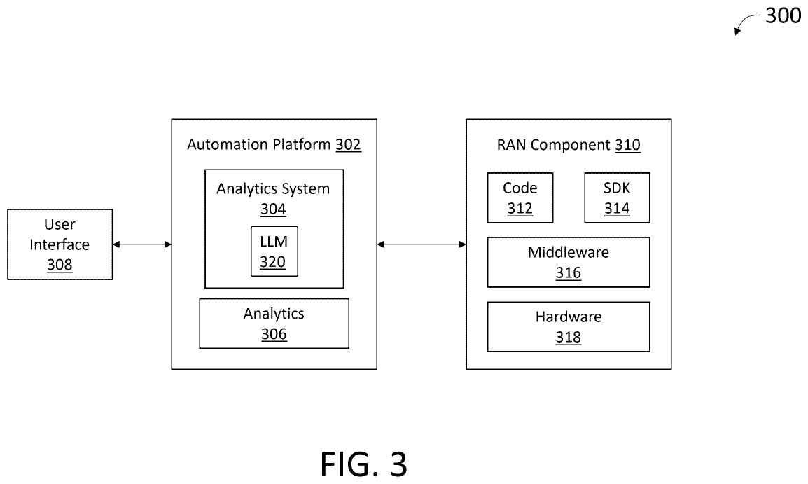

FIG. 3 illustrates another exemplary LLM enabled RAN development and deployment system 300, according to certain aspects of the present disclosure. The system 300 may include an automation platform 302 and a RAN component 310. The system 300 may support the disaggregation of RAN hardware and software components through the use of virtualized network functions (VNFs) and the automation platform 302. The RAN component 310 can leverage O-RAN hardware and software supported through the automation platform 302 to enable a more flexible, multi-vendor deployment model.

The automation platform 302 may include an analytics system 304 communicatively coupled with a user interface 308 designed to facilitate natural language interactions between an AI model powered by a large language model (LLM) 320 and a user. The analytics system 304 interprets a user's conversational request and generates a set of requirements based therefrom. The set of requirements are used to generate or select a solution. Based on a conformation of the solution from the user, the analytics system 304 generates R-DSL (e.g., a domain specific programming language) that is processed by automation platform 302 to create code or a configuration file, or such, that is used to implement the desired RAN on RAN component 310 (e.g., RAN Layer 1 (L1), O-RAN virtualized DU (vDU), etc.) to implement the solution. For example, the R-DSL may be a declarative programming language. The declarative programming language may be hardware platform independent (e.g., hardware agnostic). The R-DSL may include constraints and facts that are being evaluated by the analytics system 304. The R-DSL provides the grounding that prevents hallucinations in the LLM 320 and the specification of requirements that are outside what is possible (e.g., on the hardware, within a standard, etc.).

The user interface 308 may include a chat feature wherein the user may interact with, for example, a chatbot leveraging an AI model of the analytics system 304 to generate the text that is displayed to the user. The user may use the chat feature to make a request associated with the deployment comprising a hardware and/or software implementation of a wireless (e.g., 5G) infrastructure. The request may include descriptions of requirements for the deployment. According to embodiments, the request may be formulated based on a conversation with the chatbot. For example, the chatbot may prompt the user for additional information based on an initial request and any subsequent responses. The conversation may continue for as many iterations necessary for the user to approve a solution provided by the analytics system 304 (i.e., the request is complete). According to embodiments, the conversation can be facilitated through auditory, textual, visual, and/or other modalities. The request may be a natural language description of a desired function, hardware constraint, etc. That is, the user is not required to define every variable or any variable in a machine executable manner (i.e., as R-DSL). The solution may include graphics and other visual features. The solution may include auditory outputs. The solution may include text describing the provided solution (e.g., an explanation for how the solution meets the deployment goals).

According to embodiments, the request may be relating to an addition or modification to the deployment. The chatbot may output a confirmation, suggestion, rejection, or the like, in response to the request. In some implementations, the request may not be feasible due to limitations in the underlying system or hardware resources in the deployment. In such cases, the chatbot may generate text outputs that communicate to the user that the request cannot be fulfilled as stated. In some implementations, the chatbot provides feedback to the user on how the deployment could potentially be made possible. This may involve recommending alternative approaches, identifying adjustments (e.g., revised hardware or software requirements), or guiding the user on how to modify the request to better align with the system's capabilities. Iterations of the conversation between the user and the chatbot may be relating to an addition, modification, or clarification to a requirement of the request or any aspect of the deployment. By non-limiting example, an iteration may include a round of communication between the user and the chatbot (i.e., 1-to-1 question and answer). By non-limiting example, an iteration may include a round of communication based on topic (e.g., all communication relating to a single constraint may constitute a single iteration).

According to embodiments, the analytics system 304 may implement incremental solves for solutions by changing constraints being optimized from each iteration in the conversation (i.e., based on each response from the user). By non-limiting example, the user may initially say that having latency below a threshold value is very important for the desired deployment. A first solution may be generated based on these requirements. However, during the course of the conversation with the chatbot, the analytics system 304 may determine that a particular requirement initially identified as having low priority actually has higher priority. The user may not explicitly state the change in priority within their responses. The AI model powering the chatbot may extract the user's evolving intent and priorities based on contextual cues, such as tone, verbal cues, intonation, sentence structure, the flow of the conversation, etc.

According to embodiments, the analytics system 304 may identify requirements based on the conversation between the user and the chatbot. The analytics system 304 may rank the identified requirements based on the language used in the conversation. The analytics system 304 interprets the priority of requirements based on an analysis of the conversation (e.g., using verbal cues). By non-limiting example, the user may say that they “need” a first requirement and “would really like” a second requirement. Based on this language, the analytics system 304 may make the decision to rank (or prioritize) the first requirement over the second requirement. The chatbot may inform the user of this decision and provide an explanation (e.g., “prioritizing the first requirement produces an optimal solution based on the overall request” or “based on the language used to describe these requirements, the decision was made to prioritize the first requirement”). The user may respond by agreeing with the decision, countering the decision, clarifying intent, etc. By non-limiting example, the user may say “I want to keep the power consumption for the RAN as low as possible.” Based on this, the analytics system 304 may keep “power” as a high priority requirement. Values/definitions may also be iteratively updated the conversation progresses. That is, identified requirements may be continuously updated and refined based on the conversation.

According to some embodiments, the user's descriptions may become so unique that they require generating a new solution. The analytics system 304 may select an appropriate starting point in a current solution before generating the new solution, implying that the predicates and constraints from previous solutions are stored for continuity in the event that the analytics system 304 decides to reinstate them. The analytics system 304 informs the user, via the chatbot, that a new solution is required and estimates the time and cost involved for generating a new solution. The cost may depend on a size of an elastically assigned cluster. In some implementations, the analytics system 304 provides a range of cost-versus-time trade-off estimates based on a current solution and a new solution. In some implementations, the solutions may include details about the necessary hardware to implement a solution, along with the associated costs (such as procurement, deployment, installation, etc.). Based on the cost-versus-time trade-off estimates (and/or other knowledge of their requirements), the user may choose to follow through with the current solution or proceed with generating the new solution.

According to some embodiments, the user may not describe one or more requirements necessary to build a RAN/deployment. The analytics system 304 may generate assumptions to fill the one or more requirements that were not mentioned by the user and highlight them in the user interface 308 to make sure the assumptions are satisfactory with the user. By non-limiting example, the analytics system 304 may select an existing RU and report the selection back to the user as the most appropriate RU based on the request. The analytics system 304 may also consider the current cost of the selected RU when providing this feedback to the user.

According to some embodiments, the user may accept a provided solution and follow up with a question. For example, the user may inquire about power levels associated with the solution. The analytics system 304 may reference analytics 306 to retrieve and provide the information to the user as part of the solution. In some implementations, this may be the user's first mention of power levels. As such, the chatbot may provide the answer to the user's question. The user may accept this (e.g., “those power levels are acceptable”) or request the requirements for the solution be modified based on the provided the information (e.g., “those power levels are not acceptable”). In this instance, the conversation may recommence until an acceptable solution is reached.

According to some embodiments, the user may not have provided a sufficiently detailed or specific description of one or more requirements. In this case, the chatbot may respond through the user interface indicating that there is insufficient information to fulfill the request based on an analysis of the informal requirements by the analytics system 304. Informal requirements are grounded in the R-DSL description of the requirements. Therefore, the analytics system 304 may examine the informal requirements to determine whether there is enough grounded information to proceed with a solve. The analytics system 304 may also identify one or more features required, such as specific parameters, constraints, or use case details, that would enable the analytics system 304 to formulate an appropriate response and/or generate network programable code based on the request. By non-limiting example, the chatbot may respond to the user indicating that although the size of the RAN was adequately described, a limitation on the number of connections is required to proceed. The user can respond to the chatbot with more information relating to the specified one or more features. In some implementations, a sufficient response from the user includes indicating that a particular feature can be left to the discretion of the analytics system 304 to optimally define based on, for example, other parameters or aspects of the overall request.

According to some embodiments, the user may not agree with the solutions, constraints, or feedback generated by the analytics system 304. If the user is not satisfied, the user may describe new requirements in the conversational format via the user interface 308. The analytics system 304 may present revised solutions with revised constraints based on the additional information (i.e., the new requirements) provided by the user. In some embodiments, altered portions of a previous iteration of solutions may be adjusted in a following iteration based on new conversational descriptions from the user.

Once the user agrees with the solution (i.e., the solution is satisfactory for the desired deployment), the analytics system 304 may analyze the full conversation and convert the request into a set of machine programable constraints. The R-DSL, which can be mapped to the wireless infrastructure (e.g., RAN component 310)). The R-DSL may be updated and/or modified based on the conversation to include constraints and facts extracted from the conversation, and/or preexisting in the analytics 306 (e.g., hardware constraints that may be obtained when the user defines a target platform). According to embodiments, constraints may include both soft and hard constraints. By non-limiting example, soft constraints may include linear inequalities (e.g., “timing_x<T” or “total_dataRate<D”). By non-limiting example, hard constraints may include equalities (e.g., “number of cores=C” or “UseFEC=True”). Soft and hard constraints may be identified by the analytics system 304 based on the language used in the conversation (i.e., between user and chatbot).

According to embodiments, constraints may be prioritized and/or ranked based on the language used in the conversation. By non-limiting example, it may be apparent from the conversation that it is more important for the user to get latency below a threshold value than it is to get a number of users above a threshold value. The analytics system 304 may prioritize latency when generating the R-DSL and reporting the best case for number of users to the user before moving on with the conversation.

According to embodiments, the analytics system 304 may generate a configuration and control layer (CCL)) 312 executable by the hardware 318 from the R-DSL, causing the hardware 318 to perform a network function based on execution of the CCL 312. By non-limiting example, the automation platform 302 may then utilize this information to develop a physical data structure based on the patterns in the graph. According to embodiments, the automation platform 302 may execute testing before developing a physical data structure and/or proceeding to deployment.

The automation platform 302 may include white box components for coupling to a RAN runtime for the RAN components 310 including the configuration and control layer (CCL) 312 and a Software Development Kit (SDK) 314. The SDK may include, for example, the unit functions that constitute the RAN stack such as channel estimation and forward error correction. The unit functions in the SDK are called by the middleware under instruction from the CCL or other output of the automation platform. Middleware 316 calls unit functions in the SDK and schedules these functions on the underlying Hardware 318, under instruction from the CCL 312. In some implementations, if the user is content with the solution, the analytics system 304 may generate a test plan for the solution. This plan is crucial when assembling RAN components 310 in a lab because the analysis is conducted on a model of the components and the SDK 314. During testing, any model errors are identified and may be reported back to the RAN component 310 (or, e.g., a software supplier).

The automation platform 302 may generate results including explanations for the deployment and its metrics (e.g., power, security, performance, cost of the hardware, etc.) based on the R-DSL. The results may be stored in analytics 306. The results may include, but is not limited to, outcomes from a test strategy/plan, deployment information, performance statistics, graphics (e.g., a flattened graph of RAN elements), system configurations to meet deployment goals, observable data, etc. The proposed solutions and/or results in analytics 306 may be displayed to the user via the user interface 308 as graphical and/or textual outputs, presented in a natural and intuitive manner for the human user.

In some implementations, the automation platform 302 proposes an existing solution that appears to meet above a threshold percentage (or all) of the requirements derived from the conversion. The existing solution may be presented to the user, via the user interface 308. The chatbot may ask the user if the existing solution is suitable for the desired deployment. By non-limiting example, the automation platform 302 may extract critical paths based on performance data and display them intuitively on graphs and charts. The performance data may be stored from a previous run. In some implementations, the automation platform 302 identifies performance metrics that are most critical based on the conversation, which are then displayed on the user interface 308. In some implementations, the automation platform 302 identifies performance metrics that are most critical in response to conversational requests while referencing graphs and data from the previous run. In some implementations, the automation platform 302 provides advise for the user (e.g., “if you want to reduce critical path and save power, remove the clock cycle functions”) based on functions in the critical path.

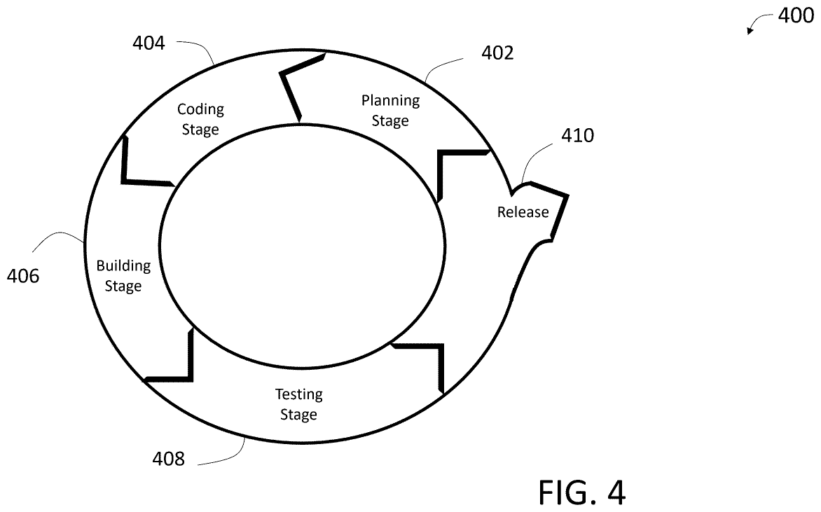

FIG. 4 illustrates a RAN development loop 400 for a RAN system, according to certain aspects of the present disclosure. The RAN development loop 400 is a continuous, iterative process that encompasses the various stages of software development. The process may enter a second operations loop after a solution is accepted by a user and prepared for release and deployment.

During a planning stage 402, the user inputs requirements for a RAN into a user interface (e.g., user interface 308). The requirements are described in a conversation format between the user and an AI chatbot via the user interface. The user interface may be integrated with an automation platform configured to facilitate stages of RAN development, deployment, and operations. The user interacts with the chatbot to discuss deployment goals and provide any additional information when necessary. The user may describe the deployment goals informally. By non-limiting example, the user's request may include hard requirements (e.g., “a private 5G network covering a ten thousand square foot area and 500 active devices”). The request may also include, but is not limited to, cost, hardware, or software constraints. By non-limiting example, the user's request may include a soft requirement (e.g., “five cameras are not needed but that is preferred”).

The RAN system (e.g., analytics system 304) may be configured to determine an existing solution having constraints that match the user's request, modify the existing solution based on the user's request, or derive a new solution to fulfil the user's request. The chatbot may provide the solution to the user based on the conversation and various described requirements. The user may continue to interact with the chatbot. In this manner, the planning stage 402 may continuously iterate until the user agrees/accepts with the provided solution. According to some embodiments, a test plan is generated based on the solution.

In some implementations, the chatbot may output an error message. For example, the chatbot may output “cannot complete request” and provide an explanation such as insufficient/missing information, hardware resource limitations, or the like. In response to this message, the user may want to change some aspects of the solution, provide new details that may result in adjustments to the solution, etc.

In some implementations, when the requirements are not feasible, the RAN system may output a solution that closely matches the request, explain what requirements could not be met, and how those requirements may have been adjusted based on an analysis of the conversation (e.g., requirement priorities). As another example, although the request as described may not be feasible to fulfill, the chatbot may provide feedback to the user on potential modifications that could remove any impediments and enable generating a viable solution. The user may, for example, choose to agree with the suggested modifications, continue conversation with the chatbot to reach the desired deployment goals, and/or propose alternative modifications.

During a coding stage 404, the RAN system (e.g., analytics system 304) generates the necessary code or CCL for RAN components (e.g., RU, DU, and CU) for the desired deployment based on the solution generated in the planning stage 402. The code may include R-DSL.

During a building stage 406, the RAN system integrates the code or CCL into the RAN components to build a model 5G network using version control (e.g., CCL 312) and automation tools (e.g., automation platform 302). The build artifacts, such as containerized RAN components, are created and prepared for testing before deployment.

During a testing stage 408, prior to deployment, the RAN system ensures the RAN meets required constraints and performance metrics (e.g., quality and functionality standards) according to a test plan (generated at the planning stage 402). According to embodiments, the user may interact with the chatbot during or after the training stage prior to releasing the code to a production environment. Based on the testing, the user may request modifications to the solution and return to the planning stage 402 for another iteration through the RAN development loop 400 or release 410 the code for deployment.

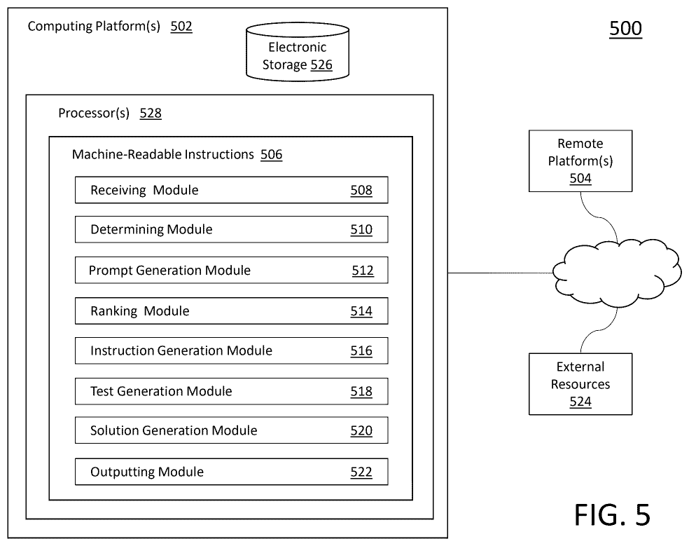

FIG. 5 illustrates a system 500 configured for RAN development, in accordance with one or more implementations. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of receiving module 508, determining module 510, prompt generation module 512, ranking module 514, instruction generation module 516, test generation module 518, solution generation module 520, and/or outputting module 522, and/or other instruction modules.

Receiving module 508 may be configured to receive, via a conversational UI, natural language (i.e., informal) inputs from a user. The conversational UI is designed to enable a natural language conversation between the user and a chatbot to discuss and identify goals for a desired RAN. The inputs may include questions, statements, descriptions, suggestions, etc. A compilation of the inputs may constitute a request from the user for the desired RAN. The request may include a set of requirements for the RAN, as described by the user in the conversation with the chatbot. The request may be regarding a new RAN deployment or modifications to an existing RAN. The chatbot is powered by an AI/ML model. The AI/ML model may leverage an LLM that formulates natural language responses to the user inputs at the conversational UI.

Determining module 510 may be configured to analyze the request and determine whether the request is valid. A request may be determined to be invalid based on hardware and/or software resources of the RAN. For example, the request may be deemed invalid if it exceeds the available hardware or software resources of the desired RAN. For instance, one or more of the requirements specified in the request may not be feasible to fulfil simultaneously. In some embodiments, the determining module 510 may be further configured to determine that the request includes an insufficient description of the RAN.

According to embodiments, the determining module 510 grounds received requests to match with a syntax of the R-DSL. The determining module 510 may discard input that is not consistent with a RAN system description as defined in the R-DSL syntax. By non-limiting example, if the user asks for the RAN to be a specific color, this may not be able to be grounded into the analytics and will be discarded.

Prompt generation module 512 may be configured to generate prompts (e.g., questions, instructions, ideas, descriptions, acknowledgments, or the like) to guide a conversation with the user via the conversation UI. The prompts may be based on the user inputs at the conversational UI. For example, the determining module 510 may determine that at least a portion of the request is invalid based on the request (i.e., including informal requirements) being grounded in the R-DSL description of the requirements. The prompt generation module 512 may be configured to generate a response, formulated by the LLM, indicating to the user the portion of the request determined to be invalid, an explanation behind the determination, or the like. For example, in the event the determining module 510 identifies that the request includes insufficient details, the prompt generation module 512 generates a prompt requesting the user provide additional details on the RAN.

According to some embodiments, the prompt generation module 512 may be further configured to generate feedback including suggestions for one or more modifications to the request that would validate an invalid request. For example, the modifications may include a suggested modification to the set of requirements. The user may accept or reject the suggested modification. For example, the receiving module 508 may receive an input from the user indicating the acceptance or rejection of the suggested modification.

Ranking module 514 may be configured to rank the one or more requirements based on a language analysis of the request. The ranking may be based on tone, contextual cues, verbal cues, intonation, and sentence structure of the request. For example, a first requirement may have greater priority than a second requirement. As such, the ranking may reflect the different priorities.

Instruction generation module 516 may be configured to generate instructions based on the request. The instructions may comprise a set of mathematically precise constraints that satisfy the set of requirements. According to embodiments, a description of the instructions may be provided to the user via the conversational UI in the form of a natural language response (formulated by the LLM). The user may approve the instructions, indicating that the set of constraints fulfils the desired RAN requirements. The user may request that the set of requirements be modified, and the set of constraints be revised to consider the modified requirements. According to some embodiments, the instructions are generated based on the ranking of the set of requirements from the ranking module 514.

According to some embodiments, the instructions may include a domain specific language that specifies the network function for the network hardware of the RAN. The instructions may be translated into code or CCL configuration file executable by the network hardware of the RAN.

According to some embodiments, the determining module 510 may be configured to analyze the instructions. Based on the analysis, the prompt generation module 512 may be configured to generate and provide more feedback to the user on characteristics (e.g., the feasibility, performance, etc., of what is requested) associated with the set of requirements specified or some other requirements identified by the system 500. By non-limiting example, the LLM may generate a response to the user such as “your request is deployable on the hardware and requires 25W of power to deploy.” The user may not have specified a power requirement, but the analysis of the request may result in identification of said power limitations. The user may be unhappy with the 25W and as a result change their requirements (i.e., modify the set of requirements) via the conversational UI. In some implementations, the analysis may determine that there is no feasible solution to a deployment with the set of constraints. As such, the system 500 may not need to work all the way to a deployment to find out that one or more requirements are not feasible. In this case, the prompt generation module 512 inform the user of these results including a reason for why the request cannot be deployed prior to performing any deployment, saving time and cost.

In some implementations, after the instructions are generated, the user adds new requirements (e.g., by asking the chatbot to add the requirement in the conversational UI). As such, updated instructions are generated based on all the requirements (i.e., the conversation with the chatbot up to a present point). That is, conversation history may be stored in a database and all the information from the database may be used to generate instructions for the user. The instructions may be iteratively updated until the user indicates that they are acceptable.

Test generation module 518 may be configured to generate a test plan based on the instructions. In some embodiments, the user makes a modification to the request based on results of an execution of the test plan. The modification may be for at least one requirement in the set of requirements. The instructions generation module 516 may update the set of constraints based on modification requested by the user such that a solution is generated based on the updated set of constraints.

Solution generation module 520 may be configured to generate, based on an approval of the instructions from the user, solution to a deployment for the network hardware of the RAN according to the instructions. In some implementations, the solution generation module 520 may incorporate the set of constraints into a complete set of constraints (e.g., existing R-DSL) and from there create the solution. The solution may be a specification for a deployment. The description of the solution may include analytics explaining the deployment. The solution may include the set of constraints designed to meet the deployment goals as described in the conversation with the chatbot. For example, the prompt generation module 512 may provide feedback include attributes of the solution (e.g., performance, use of resources, etc.) to the user.

According to some embodiments, the solution generation module 516 first provides an existing solution that closely matches the desired RAN of the user. The solution generation module 516 may identify the existing solution based on constraints of the existing solution matching at least a minimum threshold percentage of the set of requirements identified based on the request.

According to some embodiments, the solution generation module 520 may be further configured to generate the deployment based on the set of constraints. The prompt generation module 512 may be configured to generate and provide the user with feedback regarding the deployment. The feedback may include actual performance, use of resources, etc.

Outputting module 522 may be configured to output the instructions for deployment of the RAN. The outputting module 522 may be configured to output the solution to the user. For example, the solution is output to an automation tool for deployment. The outputting module 522 may be configured to output results of a deployment to the user.

In some implementations, computing platform(s) 502, remote platform(s) 504, and/or external resources 524 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 524 may be operatively linked via some other communication media.

A given remote platform 504 may include one or more processors configured to execute computer program modules. The computer program modules may be configured to enable an expert or user associated with the given remote platform 504 to interface with system 500 and/or external resources 524, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 524 may include sources of information outside of system 500, external entities participating with system 500, and/or other resources. In some implementations, some or all of the functionality attributed herein to external resources 524 may be provided by resources included in system 500.

Computing platform(s) 502 may include electronic storage 526, one or more processors 528, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 526 may comprise non-transitory storage media that electronically stores information. The electronic storage media of electronic storage 526 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 526 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 526 may include one or more virtual storage resources (e.g., cloud storage, a virtual private network, and/or other virtual storage resources). Electronic storage 526 may store software algorithms, information determined by processor(s) 528, information received from computing platform(s) 502, information received from remote platform(s) 504, and/or other information that enables computing platform(s) 502 to function as described herein.

Processor(s) 528 may be configured to provide information processing capabilities in computing platform(s) 502. As such, processor(s) 528 may include one or more of a digital processor, an analog processor, a digital circuit designed to process information, an analog circuit designed to process information, a state machine, and/or other mechanisms for electronically processing information. Although processor(s) 528 is shown in FIG. 5 as a single entity, this is for illustrative purposes only. In some implementations, processor(s) 528 may include a plurality of processing units. These processing units may be physically located within the same device, or processor(s) 528 may represent processing functionality of a plurality of devices operating in coordination. Processor(s) 528 may be configured to execute modules 508, 510, 512, 514, 516, 518, 520, and/or 522, and/or other modules. Processor(s) 528 may be configured to execute modules 508, 510, 512, 514, 516, 518, 520, and/or 522, and/or other modules by software, hardware, firmware, some combination of software, hardware, and/or firmware, and/or other mechanisms for configuring processing capabilities on processor(s) 528. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, 520, and/or 522 are illustrated in FIG. 5 as being implemented within a single processing unit, in implementations in which processor(s) 528 includes multiple processing units, one or more of modules 508, 510, 512, 514, 516, 518, 520, and/or 522 may be implemented remotely from the other modules. The description of the functionality provided by the different modules 508, 510, 512, 514, 516, 518, 520, and/or 522 described below is for illustrative purposes, and is not intended to be limiting, as any of modules 508, 510, 512, 514, 516, 518, 520, and/or 522 may provide more or less functionality than is described. For example, one or more of modules 508, 510, 512, 514, 516, 518, 520, and/or 522 may be eliminated, and some or all of its functionality may be provided by other ones of modules 508, 510, 512, 514, 516, 518, 520, and/or 522. As another example, processor(s) 528 may be configured to execute one or more additional modules that may perform some or all of the functionality attributed below to one of modules 508, 510, 512, 514, 516, 518, 520, and/or 522.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

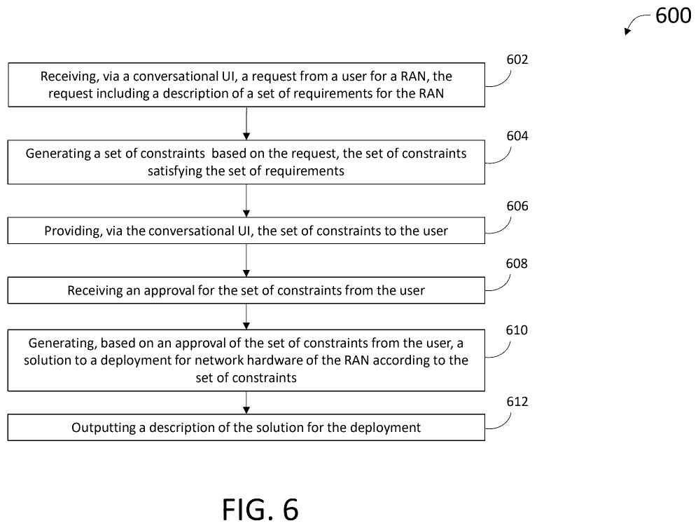

FIG. 6 illustrates an example flow diagram (e.g., process 600) for cross-platform programmable network communication, according to certain aspects of the disclosure. Further for explanatory purposes, the steps of the example process 600 are described herein as occurring in serial, or linearly. However, multiple instances of the example process 600 may occur in parallel.

At step 602, a request is received, via a conversational UI, from a user. The request may be for a desired RAN. The request may include a description of a set of requirements for the RAN.

At step 604, instructions representing a set of constraints for network hardware of the RAN is generated based on the request. The set of constraints may include a set of mathematically precise constraints that satisfy the set of requirements. For example, the set of constraints may include a domain specific language that specifies the network function for the network hardware of the RAN. In some embodiments, a target platform corresponding to the RAN includes domain specific language comprising preexisting constraints of the target platform. The generated set of constraints may specify network functions for the network hardware of the RAN in based on the request and domain specific language. In this manner, the domain specific language comprising the preexisting constraints grounds the request to the target platform constraints, generating instructions that are relevant and adhere to the target platforms requirements. In some embodiments, the set of constraints are translated into code executable by the network hardware of the RAN and the code is output to the tool.

At step 606, a description of the set of constraints are provided, in natural language description, to the user via the conversational UI. For example, the set of constraints are analyzed and characteristics of the request are generated based on the analysis. The characteristics may be provided to the user. For example, the characteristics may include resource usage, deployment requirements, performance metrics, or the like.

At step 608, the user approves the set of constraints indicating the constraints meet the desired requirements. The approval may be input by the user at the conversational UI (e.g., “this is satisfactory for my desired RAN”).

At step 610, based on the approval of the set of constraints from the user, a solution to a deployment for the network hardware of the RAN is generated according to the set of constraints. The solution may include graphics, text supporting the graphics.

At step 612, a description (in natural language) of the solution is output to the user. In some embodiments, the solution is also output to an automation tool for deployment. The method 600 may include generating the deployment based on the set of constraints and providing, to the user, feedback regarding the deployment (e.g., performance, use of resources, etc).

According to an aspect, the request may include a natural language conversation between the user and a chatbot via the conversational UI. The chatbot may be powered by an AI/ML model.

According to an aspect, the validity of the request is determined based on hardware and/or software resources of the RAN. In some implementations, the request is determined to be invalid based on 3GPP standard. By non-limiting example, the user may request more data than is allowed by the standard. When the request is determined to be invalid, the user is notified. For example, a response is provided to the user via the conversational UI indicating the portion of the request that resulted in the request being deemed invalid. The response is formulated by an LLM, and as such is output as a natural language response to the user.

According to an aspect, the user is provided with feedback including a suggested modification to the set of requirements, such that an acceptance of the modification would render the request valid. The user may accept or reject the suggested modification via the conversational UI (e.g., “I do not want to implement this modification. Can we change another parameter of the system instead?” or “yes, let's move forward with the modification,” etc.).

According to an aspect, the request may not include sufficient descriptions of the RAN for a solution to be generated. The user may be prompted, by the chatbot, to provide additional details about the RAN.

According to an aspect, requirements based on the conversation between the user and the chatbot at the conversational UI are ranked. The ranking may be based on a language analysis of the request. For example, the language analysis may include analyzing tone, contextual cues, verbal cues, intonation, and sentence structure. The set of constraints may be generated in accordance with the ranking. For example, in the event that it is not feasible for two requirements to coexist (i.e., they render the request invalid), the requirement with the lower ranking may be removed from consideration when generating a solution. If a requirement is removed from consideration, said requirement will be highlighted to the user when providing the solution.

According to an aspect, the solution is provided to the user in the form of a natural language response to the request via the conversational UI, the natural language response formulated by the LLM.

According to an aspect, an existing solution with constraints matching at least a minimum threshold percentage of the set of requirements specified in the request may be identified and provided to the user. Aspects of the existing solution that differ based on the request may be highlighted to the user. In this manner, the user can easily determine whether the adjustments are acceptable for the desired RAN.

According to an aspect, a test plan is generated based on the accepted set of constraints. The test plan may be executed for quality and performance checking. Based on the results of the execution, the user may want to change one or more aspects of the request. The user may input, via the conversational UI, a modification to the request based on the execution of the test plan. The modification may be to at least one requirement in the initial set of requirements, an addition to the initial set of requirements, or a request to remove a requirement from the initial set of requirements. According to an aspect, an updated set of constraints is generated based on the modification.

It is understood that the described systems and methods may be applied to any real-time system (RTS), and not just to RANs.

### Hardware Overview

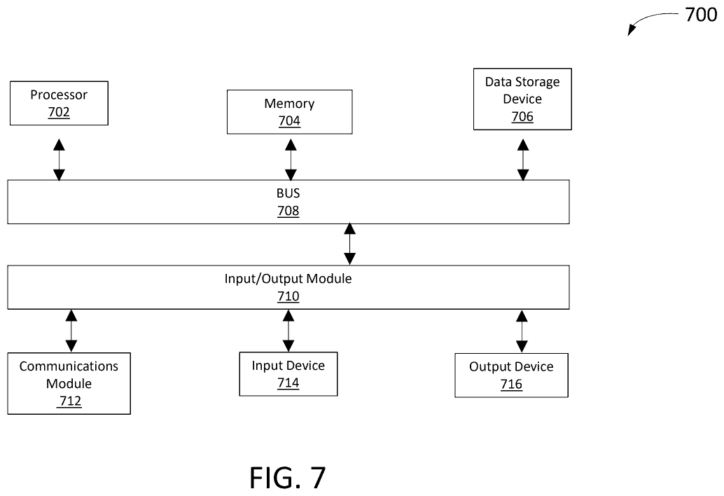

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads and processes data, information may be read from the data and stored in a memory device, such as the memory 704. Additionally, data from the memory 704 servers accessed via a network, the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for programmable network development, comprising:
receiving, via a conversational user interface (UI), a request from a user for a radio access network (RAN), the request including a first description of a set of requirements for the RAN;
generating a set of constraints for network hardware of the RAN based on the request;
providing, via the conversational UI, a second description of the set of constraints to the user;
generating, based on an approval of the set of constraints from the user, a solution to a deployment for the network hardware of the RAN according to the set of constraints; and
outputting a third description of the solution including attributes of the solution.

2. The computer-implemented method of claim 1, wherein the request comprises a natural language conversation between the user and a chatbot via the conversational UI, wherein the chatbot is powered by an artificial intelligence (AI) and/or machine learning (ML) model and the first and second descriptions are in natural language.

3. The computer-implemented method of claim 1, further comprising:
determining that at least a portion of the request is invalid based on hardware and/or software resources of the RAN;
providing a response, via the conversational UI, to the user indicating the portion of the request determined to be invalid, wherein the response is formulated by a large language model (LLM); and
providing the user with feedback including a suggested modification to the set of requirements, wherein the user accepts or rejects the suggested modification.

4. The computer-implemented method of claim 1, further comprising:
determining that the request includes an insufficient description of the RAN; and
prompting, via the conversational UI, the user to provide additional details on the RAN.

5. The computer-implemented method of claim 1, wherein a target platform corresponding to the RAN includes domain specific language comprising preexisting constraints of the target platform,
the set of constraints specify, based on the request, network functions for the network hardware of the RAN in the domain specific language, and
the domain specific language comprising the preexisting constraints grounds the request to constraints of the target platform, generating the set of constraints that are relevant and adhere to the target platform.

6. The computer-implemented method of claim 1, further comprising:
ranking the one or more requirements based on a language analysis of the request, wherein the language analysis includes a tone, contextual cues, verbal cues, intonation, and sentence structure analysis of the request; and
generating the set of constraints based on the ranking.

7. The computer-implemented method of claim 1, wherein the set of constraints and the solution are provided to the user in a form of a natural language response to the request via the conversational UI, the natural language response formulated by an LLM.

8. The computer-implemented method of claim 1, further comprising:
identifying an existing solution with constraints matching at least a minimum threshold percentage of the set of requirements specified in the request; and
providing, via the conversational UI, the existing solution to the user.

9. The computer-implemented method of claim 1, wherein the set of constraints are translated into code or configuration file executable by the network hardware of the RAN.

10. The computer-implemented method of claim 1, further comprising:
generating a test plan based on the set of constraints;
receiving, via the conversational UI, a modification to the request from the user based on an execution of the test plan, wherein the modification is to at least one requirement in the set of requirements;
updating the set of constraints based on the modification; and
generating the solution for the deployment based on an updated set of constraints.

11. The computer-implemented method of claim 1, further comprising:
analyzing the set of constraints;
generating, based on the analyzing, characteristics of the request; and
providing the characteristics to the user via the conversational UI.

12. The computer-implemented method of claim 1, further comprising:
generating the deployment based on the set of constraints; and
providing, to the user via the conversational UI, feedback regarding the deployment in the third description.

13. A system for programmable network development, comprising:
a processor; and
a memory comprising instructions stored thereon, which when executed by the processor, causes the processor to perform:
receiving, via a conversational user interface (UI), a request from a user for a radio access network (RAN), the request including a first description of a set of requirements for the RAN;
generating a set of constraints for network hardware of the RAN based on the request, the set of constraints satisfying the set of requirements;
providing, via the conversational UI, a second description of the set of constraints to the user;
generating, based on an approval of the set of constraints from the user, a solution to a deployment for the network hardware of the RAN according to the set of constraints; and
outputting a third description of the solution including attributes of the solution.

14. The system of claim 13, wherein the request comprises a natural language conversation between the user and a chatbot via the conversational UI, wherein the chatbot is powered by an artificial intelligence (AI) and/or machine learning (ML) model and the first and second descriptions are in natural language.

15. The system of claim 13, further comprising stored sequences of instructions, which when executed by the processor, cause the processor to perform:
determining that at least a portion of the request is invalid based on hardware and/or software resources of the RAN;
providing a response, via the conversational UI, to the user indicating the portion of the request determined to be invalid, wherein the response is formulated by a large language model (LLM); and
providing the user with feedback including a suggested modification to the set of requirements, wherein the user accepts or rejects the suggested modification.

16. The system of claim 13, further comprising stored sequences of instructions, which when executed by the processor, cause the processor to perform:
determining that the request includes an insufficient description of the RAN; and
prompting, via the conversational UI, the user to provide additional details on the RAN.

17. The system of claim 13, wherein a target platform corresponding to the RAN includes domain specific language comprising preexisting constraints of the target platform,
the instructions specify, based on the request, network functions for the network hardware of the RAN in the domain specific language, and
the domain specific language comprising the preexisting constraints grounds the request to constraints of the target platform, generating the set of constraints that are relevant and adhere to the target platform.

18. The system of claim 13, further comprising stored sequences of instructions, which when executed by the processor, cause the processor to perform:
ranking the one or more requirements based on a language analysis of the request, wherein the language analysis includes a tone, contextual cues, verbal cues, intonation, and sentence structure analysis of the request; and
generating the solution based on the ranking.

19. The system of claim 13, wherein the set of constraints and the solution are provided to the user in a form of a natural language response to the request via the conversational UI, the natural language response formulated by an LLM.

20. A non-transitory computer-readable storage medium comprising instructions stored thereon, which when executed by one or more processors, cause the one or more processors to perform operations for programmable network development, the operations comprising:
receiving, via a conversational user interface (UI), a request from a user for a radio access network (RAN), the request including a first description of a set of requirements for the RAN;
generating a set of constraints for network hardware of the RAN based on the request, the set of constraints satisfying the set of requirements;
providing, via the conversational UI, a second description of the set of constraints to the user;
generating, based on an approval of the set of constraints from the user, a solution to a deployment for the network hardware of the RAN according to the set of constraints; and
outputting a third description of the solution including attributes of the solution.
